(19) United States
(12) Patent Application Publication
(10) Pub. No.: US 2005/0269864 A1
(43) Pub. Date: Dec. 8, 2005

(54) Wheel and Rim Bumper

(75) Inventor: Derek Tai Tong, San Jose, CA (US)

Correspondence Address: DEREK TONG, 2091 WENDOVER LANE, SAN JOSE, CA, 95121, US

(73) Assignee: Mr. Derek Tai Tong, San Jose, CA (US)

(21) Appl. No.: 10/709,950

(22) Filed: Jun. 8, 2004

(51) Int. Cl. B60B 7/00

(52) U.S. Cl. 301/37.106

(57) ABSTRACT

The Wheel and Rim Bumper is an attachable accessory to a vehicle for purposes of protecting and decoration the wheels of the vehicle. The invention is designed to be a cost effective solution to protect the vehicle□s value and enhance the vehicle□s look.

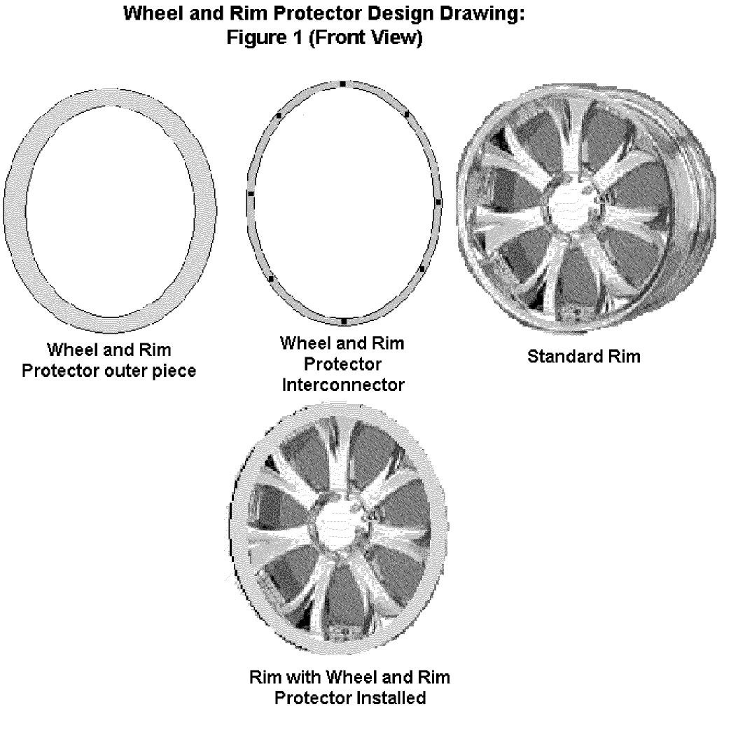

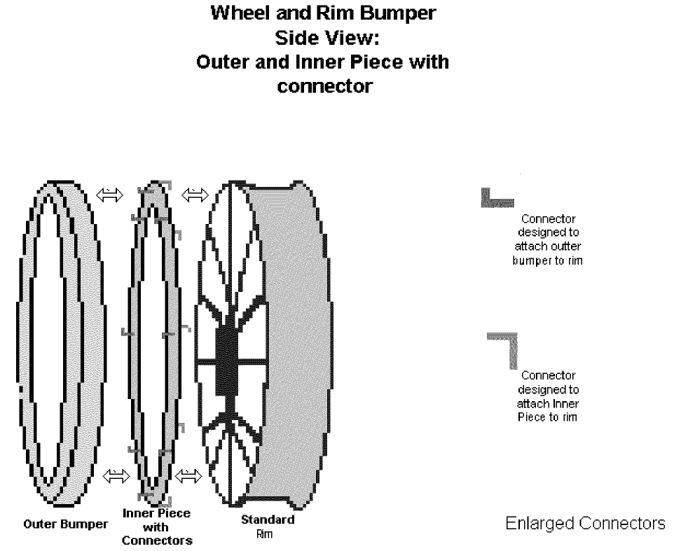

### DETAILED DESCRIPTION

The Wheel and Rim Bumper is comprised of two circular pieces: An outer piece and an inner piece to secure on rims of vehicles. The outer piece is a protective piece while the inner piece is designed to connect the rim to the outer protective layer. The securing effected by the instant invention is particularly designed to prevent damages of wheels and rims on vehicles. It can also be a decorative piece for the vehicle.

It is desirable for owners to protect their vehicles from scratches and damages while driving and parking. Accordingly, a device, constructed in accordance with the instant invention is capable of providing the protection against damages for wheels and rims of vehicles while in motion. The Wheel and Rim Bumper is designed to be disposable and easily replaceable to maintain a cost and time effective solution for owners to protect their vehicles.

1. The Inner Piece is a unique way to attach the outer protective piece to rims of a vehicle.

2. The outer piece is the protective layer that prevents scratches and damages to wheels and rims while the vehicle is in motion.

3. The outer piece and the inner piece can be easily replaced if damaged.

4. The two pieces will be designed with various sizes to fit various vehicles.

5. The unique design of the two pieces can be decorative for vehicle owners that wants to make their vehicle look more unique.

6. With regards to claim 5, both pieces can be designed to various colors to fit consumer needs.

7. With regards to claim 5, the outer piece can be design to light up during night time driving to create a unique look for the vehicle.
